(19) United States
(12) Patent Application Publication
(10) Pub. No.: US 2006/0016018 A1
(43) Pub. Date: Jan. 26, 2006

(54) Golf accessory tool

(76) Inventor: Stephen Hillenbrand, Concord, CA (US)

Correspondence Address: Stephen Hillenbrand, 937 Autumn Oak Cir., Concord, CA, 94521, US

(21) Appl. No.: 10/894,177

(22) Filed: Jul. 20, 2004

(51) Int. Cl. B25F 1/00; B67B 7/00

(52) U.S. Cl. 7/156

(57) ABSTRACT

A golf accessory tool with an elongate rigid handle, one end of the handle terminating in a double sided brush and a cleat cleaning pick, the other end of the handle terminating in a standard bottle and can opener. One side of the double sided brush has nylon or similar plastic bristles for cleaning the tops of golf shoes, golf balls and the like. The opposing brush has metal bristles that can clean golf shoe cleats and golf clubs. A preferred embodiment includes a centrally located cigar clipping device and a spring reel and tether assembly. The tether and spring reel is attached to a clip that can removably fasten to a golf bag or golf cart or belt.

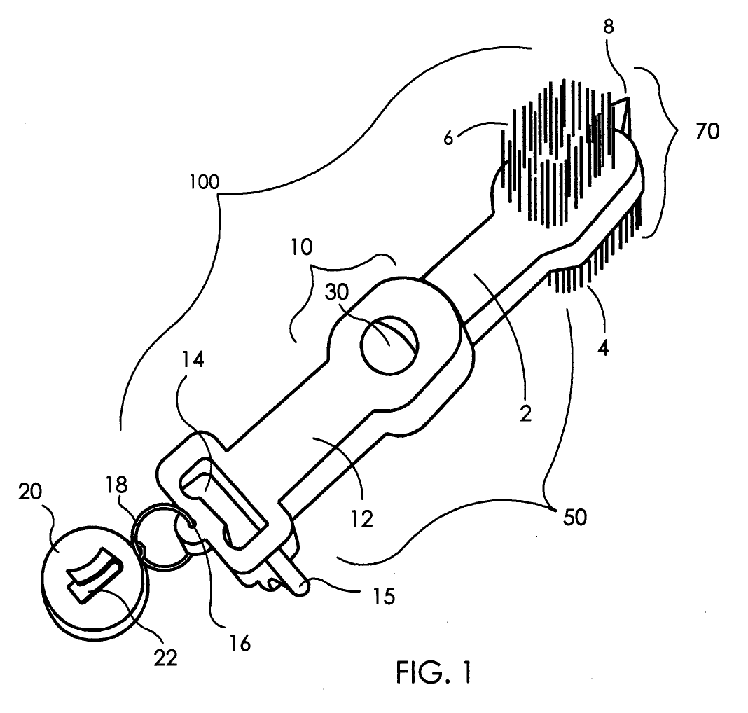

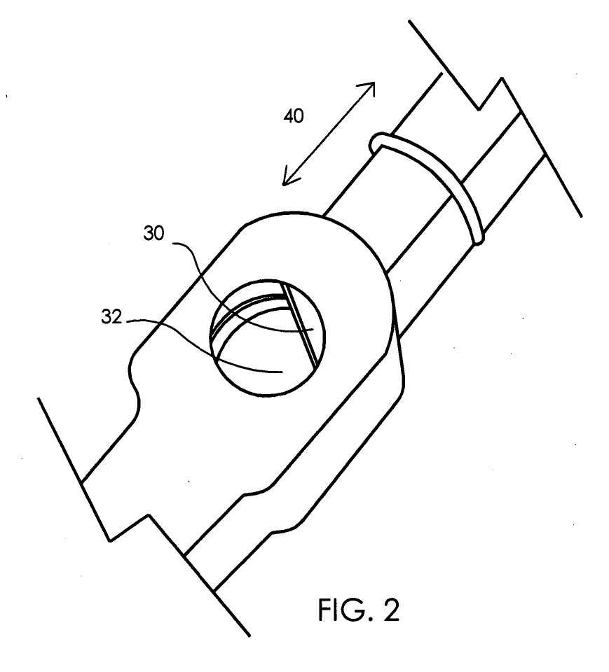

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of golfing accessories and more specifically to a multipurpose golf accessory tool.

Golf is a sport that has been practiced around the world for many years. In the process of playing golf, a person uses golf clubs to hit a golf ball, wears cleated golf shoes while on golfing on a lawn type playing field and many times smoke cigars and also become thirsty in the process of playing in the hot sun.

A number of tools or accessories have been designed and marketed to help golfers clean their clubs, balls, shoes and cleats and to help open refreshments and cut cigar tips.

Unfortunately, these tools take up valuable space in a golf bag or cart and can become easily misplaced. Additionally, the purchase of multiple tools can be quite expensive.

### BRIEF SUMMARY OF THE INVENTION

The primary object of the invention is to provide a single portable tool that can removably attach to a golfers club bag or cart that includes a cleat cleaning brush, a ball and club cleaning brush, a cleat cleaning pick, a bottle opener and a cigar clipper.

Another object of the invention is to provide a golf tool that includes a tether and spring reel so a golfer can use the tool while it remains attached to a golf bag or golf cart even during use. Another object of the invention is to provide a single golf tool that takes the place of several separate tools thereby saving space and providing economic benefits.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disposed portable golf accessory tool comprising: an elongate rigid handle, one end of said handle terminating in a double sided brush and a cleat cleaning pick, the other end of said handle terminating in a standard can or bottle opener. One side of said double sided brush having nylon or similar plastic bristles for cleaning the tops of golf shoes, golf balls and the like, the opposing brush having metal bristles that can clean golf shoe cleats and golf clubs. The opposite end of the tool includes a can and bottle opening device. A cigar clipping tool is integrated into the handle portion.

What is claimed is:

1. A golf accessory tool comprising:
an elongate rigid handle, one end of said handle terminating in a double sided brush and a cleat cleaning pick, the opposite end of said handle terminating in a standard bottle and can opening tool;
said handle constructed of a partially telescoping first and second part, wherein said first part includes a cigar sized aperture and said second part includes a cigar clipping blade so that the user can pull said first and second handle parts apart, insert a cigar tip and push said handle parts together thereby clipping the tip of said cigar;
one of said brushes having plastic bristles for cleaning the tops of golf shoes and golf balls, the opposing brush having metal bristles that can clean golf shoe cleats and golf clubs;
said cleat cleaning pick integrated into the most far end of the brush side of said elongate handle so that it is positioned in between and parallel to said brushes.
